(19) United States
(12) Patent Application Publication
(10) Pub. No.: US 2026/0290260 A1
(43) Pub. Date: Sep. 24, 2026

(54) DISPLAY DEVICE AND ELECTRONIC DEVICE

(71) Applicant: Samsung Display Co., LTD., Yongin-si (KR)

(72) Inventors: Jin Seon KWAK, Yongin-si (KR); Jang Mi KANG, Yongin-si (KR); Kyung Bae KIM, Yongin-si (KR); Yong Hee LEE, Yongin-si (KR); Yun Jang PYUN, Yongin-si (KR)

(21) Appl. No.: 19/559,625

(22) Filed: Mar. 6, 2026

(30) Foreign Application Priority Data
Mar. 18, 2025 (KR) 10-2025-0034675

(51) Int. Cl. G09G 3/3275; G09G 3/32

(52) U.S. Cl. CPC G09G 3/3275; G09G 3/32; G09G 2310/027; G09G 2310/0275; G09G 2320/0271

(57) ABSTRACT

A display device includes: a display panel including a display area and a non-display area; a data driving circuit in the non-display area; and a gamma circuit generating a plurality of grayscale voltages, wherein the data driving circuit includes a data processing circuit processing digital image data and a data output circuit converting the digital image data into an analog image signal based on the plurality of grayscale voltages and providing the analog image signal to the display area, the data output circuit includes a first, second, and third output channels that are connected to the data processing circuit, and the first output channel and the second output channel are adjacent to each other in a width direction of the third output channel, and the third output channel is adjacent to the first output channel and the second output channel in a length direction of the first output channel.

### CROSS-REFERENCE TO RELATED APPLICATION

The present application claims priority to and the benefit of Korean Patent Application No. 10-2025-0034675, filed on Mar. 18, 2025, in the Korean Intellectual Property Office, the entire disclosure of which is incorporated herein by reference.

### BACKGROUND

### 1. Field

Aspects of some embodiments of the present disclosure relate to a display device and an electronic device including the same.

### 2. Description of the Related Art

Organic light emitting diode displays have self-luminous properties and do not require separate light sources unlike liquid crystal displays, and may thus may have a reduced thickness and weight. In addition, the organic light emitting diode displays have attracted attention as next-generation display devices for televisions (TVs), monitors, portable electronic devices because they exhibit high-quality characteristics such as low power consumption, high luminance, and a high response speed.

The above information disclosed in this Background section is only for enhancement of understanding of the background and therefore the information discussed in this Background section does not necessarily constitute prior art.

### SUMMARY

Aspects of some embodiments of the present disclosure relate to a display device and an electronic device including the same, and for example, to a display device and an electronic device in which a great number of output channels may be integrated.

Aspects of some embodiments of the present disclosure include a display device and an electronic device in which a great number of output channels may be integrated.

According to some embodiments of the present disclosure, a display device includes: a display panel including a display area and a non-display area; a data driving circuit in the non-display area; and a gamma circuit generating a plurality of grayscale voltages, wherein the data driving circuit includes a data processing circuit processing digital image data and a data output circuit converting the digital image data from the data processing circuit into an analog image signal based on the plurality of grayscale voltages from the gamma circuit and providing the analog image signal to the display area, the data output circuit includes a first output channel, a second output channel, and a third output channel that are connected to the data processing circuit, and the first output channel and the second output channel are adjacent to each other in a width direction of the third output channel, and the third output channel is adjacent to the first output channel and the second output channel in a length direction of the first output channel.

According to some embodiments of the present disclosure, an electronic device includes a display device providing a display screen, wherein the display device includes: a display panel including a display area and a non-display area; a data driving circuit in the non-display area; and a gamma circuit generating a plurality of grayscale voltages, the data driving circuit includes a data processing circuit processing digital image data and a data output circuit converting the digital image data from the data processing circuit into an analog image signal based on the plurality of grayscale voltages from the gamma circuit and providing the analog image signal to the display area, the data output circuit includes a first output channel, a second output channel, and a third output channel that are connected to the data processing circuit, and the first output channel and the second output channel are adjacent to each other in a width direction of the third output channel, and the third output channel is adjacent to the first output channel and the second output channel in a length direction of the first output channel.

With a display device and an electronic device according to some embodiments, a great number of output channels may be integrated.

For example, according to some embodiments, a length of a third output channel is smaller than a length of a first output channel and a length of a second output channel, whereas a width of the third output channel is greater than a width of the first output channel and a width of the second output channel, the first output channel and the second output channel are adjacent to each other in a width direction of the third output channel, and the third output channel is adjacent to the first output channel and the second output channel in a length direction of the first output channel, and accordingly, a length and a width of a group output channel including such first to third output channels may be optimized. Accordingly, a great number of output channels may be integrated even in a non-display area having a small area.

In addition, an exposure process may be performed in one shot during a photolithography process for forming a data output circuit including a plurality of group output channels described above.

The characteristics of embodiments according to the present disclosure are not limited to the above-described characteristics and other characteristics which are not described herein will become more apparent to those skilled in the art from the following description.

### BRIEF DESCRIPTION OF THE DRAWINGS

The above and other aspects and features of embodiments according to the present disclosure will become more apparent by describing in more detail aspects of some embodiments thereof with reference to the attached drawings, in which:

FIG. 1 is an exploded perspective view illustrating a display device according to some embodiments;

FIG. 2 is a block diagram illustrating the display device according to some embodiments;

FIG. 3 is an equivalent circuit diagram of a first sub-pixel according to some embodiments;

FIG. 4 is a layout diagram illustrating an example of a display panel according to some embodiments;

FIG. 5 is a diagram illustrating a detailed configuration of a first data driving circuit of FIG. 4;

FIG. 6 is an array diagram of output channels for providing data voltages to sub-pixels included in one pixel;

FIG. 7 is an array diagram of output channels for providing data voltages to sub-pixels included in one pixel;

FIG. 8 is a block diagram of an electronic device according to some embodiments; and

FIGS. 9 to 11 are schematic views of electronic devices according to some embodiments.

### DETAILED DESCRIPTION

Aspects of some embodiments of the present disclosure will now be described more fully hereinafter with reference to the accompanying drawings, in which aspects of some embodiments of the invention are shown. This invention may, however, be embodied in different forms and should not be construed as limited to the embodiments set forth herein. Rather, these embodiments are provided so that this disclosure will be thorough and complete, and will more fully convey the scope of embodiments according to the invention to those skilled in the art.

It will also be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

Features of various embodiments of the present disclosure may be combined partially or totally. As will be clearly appreciated by those skilled in the art, technically various interactions and operations are possible. Various embodiments can be practiced individually or in combination.

Hereinafter, aspects of some embodiments will be described in more detail with reference to the accompanying drawings.

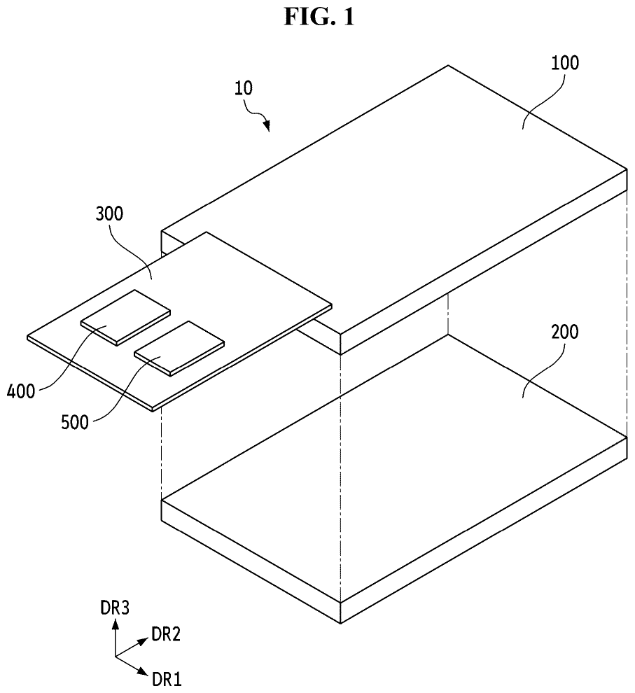

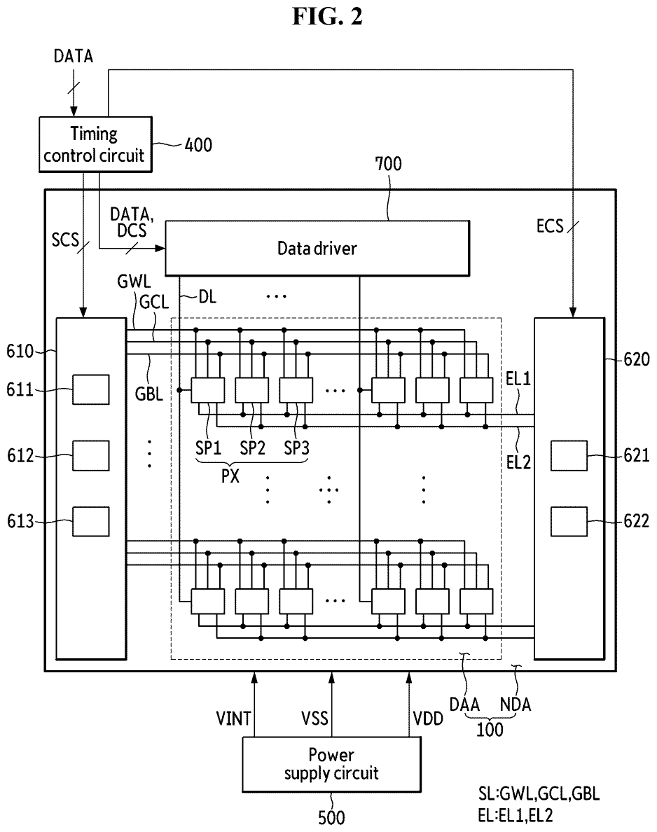

FIG. 1 is an exploded perspective view illustrating a display device according to some embodiments. FIG. 2 is a block diagram illustrating the display device according to some embodiments.

Referring to FIGS. 1 and 2, a display device 10 according to some embodiments is a device that displays moving images (e.g., video images) or still images (e.g., static images). The display device 10 according to some embodiments may be applied to portable electronic devices such as mobile phones, smartphones, tablet personal computers (PCs), mobile communication terminals, electronic notebooks, electronic books, portable multimedia players (PMPs), navigation devices, and ultra mobile PCs (UMPCs). For example, the display device 10 according to some embodiments may be applied as a display unit of televisions, laptop computers, monitors, billboards, or the Internet of Things (IOTs). Alternatively, the display device 10 according to some embodiments may be applied to smart watches, watch phones, or head mounted displays (HMDs) for implementing virtual reality and augmented reality.

The display device 10 according to some embodiments includes a display panel 100, a heat dissipation layer 200, a circuit board 300, a timing control circuit 400, and a power supply circuit 500.

The display panel 100 may have a shape similar to a rectangular shape in a plan view (e.g., a view perpendicular to a display surface of the display panel 100). For example, the display panel 100 may have a shape similar to a rectangular shape, in a plan view, having short sides in a first direction DR1 and long sides in a second direction DR2 crossing the first direction DR1. In the display panel 100, a corner where the short side in the first direction DR1 and the long side in the second direction DR2 meet may be rounded with a selected curvature or right-angled. A shape of the display panel 100 in a plan view is not limited to the rectangular shape, and may be a shape similar to other polygonal shapes, a circular shape, an elliptical shape, or an irregular shape. A shape of the display device 10 in a plan view may follow the shape of the display panel 100 in a plan view, but embodiments of the present disclosure are not limited thereto.

The display panel 100 includes a plurality of pixels PX, a plurality of scan lines SL, a plurality of emission control lines EL, a plurality of data lines DL, a scan driver 610, an emission driver 620, and a data driver 700. The display panel 100 may be divided into a display area DAA that displays images and a non-display area NDA that does not display images, as illustrated in FIG. 2. According to some embodiments, the non-display area NDA may surround (e.g., in a periphery or outside a footprint of) the display area DAA.

The plurality of pixels PX may be located in the display area DAA. The plurality of pixels PX may be arranged in a matrix form or arrangement (e.g., of rows and columns) in the first direction DR1 and the second direction DR2. The plurality of scan lines SL and the plurality of emission control lines EL may extend in the first direction DR1 and may be arranged in the second direction DR2. The plurality of data lines DL may extend in the second direction DR2 and may be arranged in the first direction DR1.

The plurality of scan lines SL include a plurality of write scan lines GWL, a plurality of control scan lines GCL, and a plurality of bias scan lines GBL. The plurality of emission control lines EL include a plurality of first emission control lines EL1 and a plurality of second emission control lines EL2.

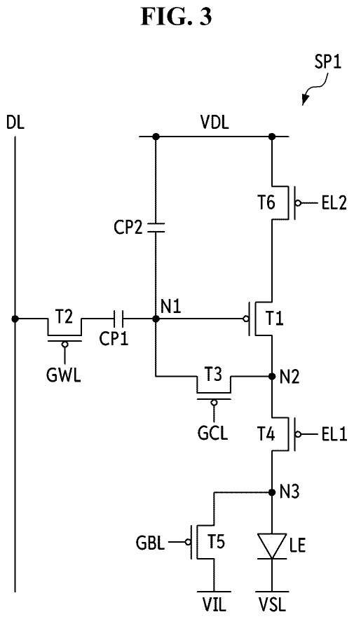

Each of the plurality of pixels PX includes a plurality of sub-pixels SP1, SP2, and SP3. The plurality of sub-pixels SP1, SP2, and SP3 may include a plurality of pixel transistors as illustrated in FIG. 3, and the plurality of pixel transistors may be formed by a semiconductor process and located on a semiconductor substrate. For example, the plurality of pixel transistors may be formed as complementary metal oxide semiconductors (CMOSs), but embodiments of the present disclosure are not limited thereto.

Each of the plurality of sub-pixels SP1, SP2, and SP3 may be connected to any one of the plurality of write scan lines GWL, any one of the plurality of control scan lines GCL, any one of the plurality of bias scan lines GBL, any one of the plurality of first emission control lines EL1, any one of the plurality of second emission control lines EL2, and any one of the plurality of data lines DL. Each of the plurality of sub-pixels SP1, SP2, and SP3 may receive a data voltage of the data line DL according to a write scan signal of the write scan line GWL, and allow a light emitting element to emit light according to the data voltage.

The scan driver 610, the emission driver 620, and the data driver 700 may be located in the non-display area NDA.

The scan driver 610 includes a plurality of scan transistors, and the emission driver 620 includes a plurality of emission transistors. The plurality of scan transistors and the plurality of emission transistors may be formed through a semiconductor process and formed on the semiconductor substrate. For example, the plurality of scan transistors and the plurality of emission transistors may be formed as CMOSs, but embodiments of the present disclosure are not limited thereto.

The scan driver 610 may include a write scan signal output unit 611, a control scan signal output unit 612, and a bias scan signal output unit 613. Each of the write scan signal output unit 611, the control scan signal output unit 612, and the bias scan signal output unit 613 may receive a scan timing control signal SCS from the timing control circuit 400. The write scan signal output unit 611 may generate write scan signals according to the scan timing control signal SCS of the timing control circuit 400 and sequentially output the write scan signals to the write scan lines GWL. The control scan signal output unit 612 may generate control scan signals according to the scan timing control signal SCS and sequentially output the control scan signals to the control scan lines GCL. The bias scan signal output unit 613 may generate bias scan signals according to the scan timing control signal SCS and sequentially output the bias scan signals to the bias scan lines GBL.

The emission driver 620 includes a first emission control driver 621 and a second emission control driver 622. Each of the first emission control driver 621 and the second emission control driver 622 may receive an emission timing control signal ECS from the timing control circuit 400. The first emission control driver 621 may generate first emission control signals according to the emission timing control signal ECS and sequentially output the first emission control signals to the first emission control lines EL1. The second emission control driver 622 may generate second emission control signals according to the emission timing control signal ECS and sequentially output the second emission control signals to the second emission control lines EL2.

The data driver 700 may include a plurality of data transistors, and the plurality of data transistors may be formed by a semiconductor process and formed on the semiconductor substrate. For example, the plurality of data transistors may be formed as CMOSs, but embodiments of the present disclosure are not limited thereto.

The data driver 700 may receive digital video data DATA and a data timing control signal DCS from the timing control circuit 400. The data driver 700 converts the digital video data DATA into analog data voltages according to the data timing control signal DCS and outputs the analog data voltages to the data lines DL. In this case, the sub-pixels SP1, SP2, and SP3 may be selected by the write scan signals of the scan driver 610, and the data voltages may be supplied to the selected sub-pixels SP1, SP2, and SP3.

The heat dissipation layer 200 may overlap the display panel 100 in a third direction DR3, which is a thickness direction of the display panel 100. The heat dissipation layer 200 may be located on one surface, for example, a rear surface, of the display panel 100. The heat dissipation layer 200 serves to dissipate heat generated from the display panel 100. The heat dissipation layer 200 may include a layer made of graphite or metal such as silver (Ag), copper (Cu), or aluminum (Al) having high thermal conductivity.

The circuit board 300 may be electrically connected to a plurality of pads of a pad unit of the display panel 100 using a conductive adhesive member such as an anisotropic conductive film. The circuit board 300 may be a flexible printed circuit board or a flexible film having a flexible material. It has been illustrated in FIG. 1 that the circuit board 300 is unbent, but the circuit board 300 may be bent. In this case, one end of the circuit board 300 may be located on the rear surface of the display panel 100 and/or a rear surface of the heat dissipation layer 200. The other end of the circuit board 300 may be connected to the plurality of pads of the pad unit of the display panel 100 using the conductive adhesive member. One end of the circuit board 300 may be an end opposite to the other end of the circuit board 300.

The timing control circuit 400 may receive digital video data and timing signals from the outside. The timing control circuit 400 may generate the scan timing control signal SCS, the emission timing control signal ECS, and the data timing control signal DCS for controlling the display panel 100 according to the timing signals. The timing control circuit 400 may output the scan timing control signal SCS to the scan driver 610 and output the emission timing control signal ECS to the emission driver 620. The timing control circuit 400 may output the digital video data and the data timing control signal DCS to the data driver 700.

The power supply circuit 500 may generate a plurality of panel driving voltages according to an external source voltage. For example, the power supply circuit 500 may generate a first driving voltage VSS, a second driving voltage VDD, and a third driving voltage VINT and supply the first driving voltage VSS, the second driving voltage VDD, and the third driving voltage VINT to the display panel 100. The first driving voltage VSS, the second driving voltage VDD, and the third driving voltage VINT will be described later with reference to FIG. 3.

Each of the timing control circuit 400 and the power supply circuit 500 may be formed as an integrated circuit (IC) and attached to one surface of the circuit board 300. In this case, the scan timing control signal SCS, the emission timing control signal ECS, the digital video data DATA, and the data timing control signal DCS of the timing control circuit 400 may be supplied to the display panel 100 through the circuit board 300. In addition, the first driving voltage VSS, the second driving voltage VDD, and the third driving voltage VINT of the power supply circuit 500 may be supplied to the display panel 100 through the circuit board 300.

Alternatively, each of the timing control circuit 400 and the power supply circuit 500 may be located in the non-display area NDA of the display panel 100, similar to the scan driver 610, the emission driver 620, and the data driver 700. In this case, the timing control circuit 400 may include a plurality of timing transistors, and the power supply circuit 500 may include a plurality of power transistors. The plurality of timing transistors and the plurality of power transistors may be formed through a semiconductor process and formed on the semiconductor substrate. For example, the plurality of timing transistors and the plurality of power transistors may be formed as CMOSs, but embodiments of the present disclosure are not limited thereto. Each of the timing control circuit 400 and the power supply circuit 500 may be located between the data driver 700 and the pad unit.

FIG. 3 is an equivalent circuit diagram of a first sub-pixel according to some embodiments. Although FIG. 3 illustrates various components in a sub-pixel according to some embodiments, embodiments according to the present disclosure are not limited thereto, and according to various embodiments, the sub-pixel may include additional components, or fewer components, without departing from the spirit and scope of embodiments according to the present disclosure.

Referring to FIG. 3, a first sub-pixel SP1 may be connected to a write scan line GWL, a control scan line GCL, a bias scan line GBL, a first emission control line EL1, a second emission control line EL2, and a data line DL. In addition, the first sub-pixel SP1 may be connected to a first driving voltage line VSL to which the first driving voltage VSS corresponding to a low potential voltage is applied, a second driving voltage line VDL to which the second driving voltage VDD corresponding to a high potential voltage is applied, and a third driving voltage line VIL to which the third driving voltage VINT corresponding to an initialization voltage is applied. That is, the first driving voltage line VSL may be a low potential voltage line, the second driving voltage line VDL may be a high potential voltage line, and the third driving voltage line VIL may be an initialization voltage line. In this case, the first driving voltage VSS may be a voltage lower than the third driving voltage VINT. The second driving voltage VDD may be a voltage higher than the third driving voltage VINT.

The first sub-pixel SP1 includes a plurality of transistors T1 to T6, a light emitting element LE, a first capacitor CP1, and a second capacitor CP2.

The light emitting element LE emits light according to a driving current Ids flowing through a channel of a first transistor T1. An amount of light emitted from the light emitting element LE may be proportional to the driving current. The light emitting element LE may be located between a fourth transistor T4 and the first driving voltage line VSL. A first electrode of the light emitting element LE may be connected to a drain electrode of the fourth transistor T4, and a second electrode of the light emitting element LE may be connected to the first driving voltage line VSL. The first electrode of the light emitting element LE may be an anode electrode, and the second electrode of the light emitting element LE may be a cathode electrode. The light emitting element LE may be an organic light emitting diode including a first electrode, a second electrode, and an organic light emitting layer located between the first electrode and the second electrode, but embodiments of the present disclosure are not limited thereto. For example, the light emitting element LE may be an inorganic light emitting element including a first electrode, a second electrode, and an inorganic semiconductor located between the first electrode and the second electrode, and in this case, the light emitting element LE may be a micro light emitting diode.

The first transistor T1 may be a driving transistor controlling a source-drain current Ids (hereinafter referred to as a “driving current”) flowing between a source electrode and a drain electrode according to a voltage applied to a gate electrode thereof. The first transistor T1 includes the gate electrode connected to a first node N1, the source electrode connected to a drain electrode of a sixth transistor T6, and the drain electrode connected to a second node N2.

A second transistor T2 may be located between one electrode of the first capacitor CP1 and the data line DL. The second transistor T2 is turned on by a write scan signal of the write scan line GWL to connect one electrode of the first capacitor CP1 to the data line DL. For this reason, a data voltage of the data line DL may be applied to one electrode of the first capacitor CP1. The second transistor T2 includes a gate electrode connected to the write scan line GWL, a source electrode connected to the data line DL, and a drain electrode connected to one electrode of the first capacitor CP1.

A third transistor T3 may be located between the first node N1 and the second node N2. The third transistor T3 is turned on by a control scan signal of the control scan line GCL to connect the first node N1 to the second node N2. For this reason, when the gate electrode and the drain electrode of the first transistor T1 are connected to each other, the first transistor T1 may operate like a diode. The third transistor T3 includes a gate electrode connected to the control scan line GCL, a source electrode connected to the second node N2, and a drain electrode connected to the first node N1.

The fourth transistor T4 may be connected between the second node N2 and a third node N3. The fourth transistor T4 is turned on by a first emission control signal of the first emission control line EL1 to connect the second node N2 to the third node N3. For this reason, the driving current of the first transistor T1 may be supplied to the light emitting element LE. The fourth transistor T4 includes a gate electrode connected to the first emission control line EL1, a source electrode connected to the second node N2, and the drain electrode connected to the third node N3.

A fifth transistor T5 may be located between the third node N3 and the third driving voltage line VIL. The fifth transistor T5 is turned on by a bias scan signal of the bias scan line GBL to connect the third node N3 to the third driving voltage line VIL. For this reason, the third driving voltage VINT of the third driving voltage line VIL may be applied to the first electrode of the light emitting element LE. The fifth transistor T5 includes a gate electrode connected to the bias scan line GBL, a source electrode connected to the third node N3, and a drain electrode connected to the third driving voltage line VIL.

The sixth transistor T6 may be located between the source electrode of the first transistor T1 and the second driving voltage line VDL. The sixth transistor T6 is turned on by a second emission control signal of the second emission control line EL2 to connect the source electrode of the first transistor T1 to the second driving voltage line VDL. For this reason, the second driving voltage VDD of the second driving voltage line VDL may be applied to the source electrode of the first transistor T1. The sixth transistor T6 includes a gate electrode connected to the second emission control line EL2, a source electrode connected to the second driving voltage line VDL, and the drain electrode connected to the source electrode of the first transistor T1.

The first capacitor CP1 is formed between the first node N1 and the drain electrode of the second transistor T2. The first capacitor CP1 includes one electrode connected to the drain electrode of the second transistor T2 and the other electrode connected to the first node N1.

The second capacitor CP2 is formed between the gate electrode of the first transistor T1 and the second driving voltage line VDL. The second capacitor CP2 includes one electrode connected to the gate electrode of the first transistor T1 and the other electrode connected to the second driving voltage line VDL.

The first node N1 is a contact point between the gate electrode of the first transistor T1, the drain electrode of the third transistor T3, the other electrode of the first capacitor CP1, and one electrode of the second capacitor CP2. The second node N2 is a contact point between the drain electrode of the first transistor T1, the source electrode of the third transistor T3, and the source electrode of the fourth transistor T4. The third node N3 is a contact point between the drain electrode of the fourth transistor T4, the source electrode of the fifth transistor T5, and the first electrode of the light emitting element LE.

Each of the first to sixth transistors T1 to T6 may be a metal oxide semiconductor field effect transistor (MOSFET). For example, each of the first to sixth transistors T1 to T6 may be a P-type MOSFET, but embodiments of the present disclosure are not limited thereto. Each of the first to sixth transistors T1 to T6 may be an N-type MOSFET. Alternatively, some of the first to sixth transistors T1 to T6 may be P-type MOSFETs, and the others of the first to sixth transistors T1 to T6 may be N-type MOSFETs.

It has been illustrated in FIG. 3 that the first sub-pixel SP1 includes six transistors T1 to T6 and two capacitors CP1 and CP2, but an equivalent circuit diagram of the first sub-pixel SP1 is not limited to that illustrated in FIG. 3.

In addition, an equivalent circuit diagram of a second sub-pixel SP2 and an equivalent circuit diagram of a third sub-pixel SP3 may be the same (or substantially the same) as the equivalent circuit diagram of the first sub-pixel SP1 described with reference to FIG. 3. Therefore, some description of the equivalent circuit diagram of the second sub-pixel SP2 and the equivalent circuit diagram of the third sub-pixel SP3 may be omitted.

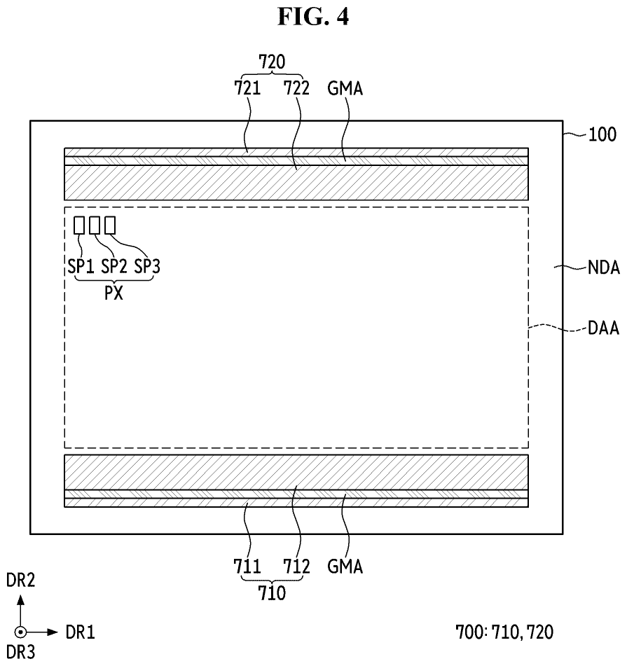

FIG. 4 is a layout diagram illustrating an example of a display panel 100 according to some embodiments.

Referring to FIG. 4, the display area DAA of the display panel 100 according to some embodiments may include a plurality of pixels PX arranged in a matrix form. The pixel PX may include a first sub-pixel SP1, a second sub-pixel SP2, and a third sub-pixel SP3 adjacent to each other.

The data driver 700 may be located in the non-display area NDA of the display panel 100 according to some embodiments. The scan driver 610 and the emission driver 620 described above may be further located in the non-display area NDA of the display panel 100.

The data driver 700 may include a first data driving circuit 710 and a second data driving circuit 720.

The first data driving circuit 710 may be located in a non-display area NDA on a lower side of the display area DAA. For example, the first data driving circuit 710 may be located on one side of the display area DAA in the second direction DR2.

The first data driving circuit 710 may process first digital image data signals from the timing control circuit 400, convert the processed first digital image data signals into analog signals, and provide the analog signals to first data lines. In this case, the analog signals from the first data driving circuit 710 may be provided to the first data lines through a first distribution circuit (e.g., a demultiplexer). Here, the data lines DL may include a plurality of first data lines and a plurality of second data lines, and the first data driving circuit 710 may provide the analog signals to the first data lines through the first distribution circuit.

The first data driving circuit 710 may include a first data processing circuit 711 and a first data output circuit 712.

The first data processing circuit 711 may process first digital image data signals from the timing control circuit 400 and provide the processed first digital image data signals to the first data output circuit 712.

The first data output circuit 712 may convert the first digital image data signals processed by the first data processing circuit 711 into analog signals and provide the converted analog signals to the first data lines through the first distribution circuit.

The number of channels of the first distribution circuit may be the same as the number of first data lines, and the number of channels of the first data output circuit 712 may be smaller than the number of channels of the first distribution circuit.

The second data driving circuit 720 may be located in a non-display area NDA on an upper side of the display area DAA. For example, the second data driving circuit 720 may be located on the other side of the display area DAA in the second direction DR2. In other words, the second data driving circuit 720 and the first data driving circuit 710 may be located in the non-display area NDA so as to face each other in the second direction DR2 with the display area DAA. The display area DAA may be located between the second data driving circuit 720 and the first data driving circuit 710.

The second data driving circuit 720 may process second digital image data signals from the timing control circuit 400, convert the processed second digital image data signals into analog signals, and provide the analog signals to second data lines. In this case, the analog signals from the second data driving circuit 720 may be provided to the second data lines through a second distribution circuit (e.g., a demultiplexer).

The second data driving circuit 720 may include a second data processing circuit 721 and a second data output circuit 722.

The second data processing circuit 721 may process second digital image data signals from the timing control circuit 400 and provide the processed second digital image data signals to the second data output circuit 722.

The second data output circuit 722 may convert the second digital image data signals processed by the second data processing circuit 721 into analog signals and provide the converted analog signals to the second data lines through the second distribution circuit.

The number of channels of the second distribution circuit may be the same as the number of second data lines, and the number of channels of the second data output circuit 722 may be smaller than the number of channels (e.g., output channels) of the second distribution circuit.

Gamma circuits GMA may be located between the first data processing circuit 711 and the first data output circuit 712, and between the second data processing circuit 721 and the second data output circuit 722, respectively. The gamma circuits GMA may generate a plurality of grayscale voltages by dividing a gamma reference voltage, and provide the plurality of grayscale voltages (e.g., grayscale voltages of 0 to 255 grayscale levels) to the data driver 700. For example, the gamma circuits GMA may provide the plurality of grayscale voltages to the first data output circuit 712 and the second data output circuit 722. The first data output circuit 712 may select a grayscale voltage corresponding to the first digital image data signal from the gamma circuit GMA and output the selected grayscale voltage as a first analog image signal (e.g., a data voltage). Similarly, the second data output circuit 722 may select a grayscale voltage corresponding to the second digital image data signal from the gamma circuit GMA and output the selected grayscale voltage as a second analog image signal (e.g., a data voltage). Here, the gamma circuit GMA may generate a plurality of red grayscale voltages for red image data, a plurality of blue grayscale voltages for blue image data, and a plurality of green grayscale voltages for green image data.

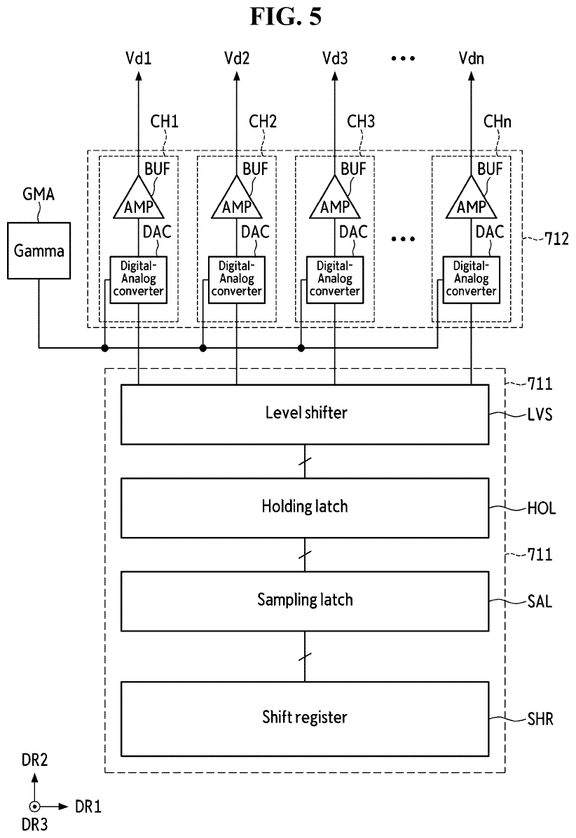

FIG. 5 is a diagram illustrating a detailed configuration of a first data driving circuit 710 of FIG. 4.

The first data driving circuit 710 may include the first data processing circuit 711 and the first data output circuit 712, as illustrated in FIG. 5.

The first data processing circuit 711 may include a shift register SHR (e.g., a data shift register), a sampling latch SAL (e.g., a data sampling latch), a holding latch HOL (e.g., a data holding latch), and a level shifter LVS (e.g., a data level shifter).

The shift register SHR may receive a source shift clock and a source start pulse from the timing control circuit 400, and may sequentially generate a plurality of sampling signals while shifting the source start pulse every cycle of the source shift clock.

The sampling latch SAL may sequentially store a plurality of first digital image data signals in response to the plurality of sampling signals sequentially supplied from the shift register SHR.

The holding latch HOL may receive and store the first digital image data signal from the sampling latch SAL and output a sampled first digital image data signal that was stored in a previous period, in response to a source output enable. The first digital image data signal output from the holding latch HOL may be provided to the first data output circuit 712 through the level shifter LVS.

The level shifter LVS may convert a level of the first digital image data signal from the holding latch HOL and provide the first digital image data signal whose level is converted to the first data output circuit 712. For example, the level shifter LVS may convert the level of the first digital image data signal so that the first digital image data signal has a level that may drive transistors of a digital-analog converter DAC provided in the first data output circuit 712.

The first data output circuit 712 may include a plurality of output channels CH1, CH2, CH3, . . . , CHn connected to the first data processing circuit 711 (e.g., the level shifter LVS). The output channels CH1, CH2, CH3, . . . , CHn may output data voltages Vd1, Vd2, Vd3, . . . , Vdn. Each of the output channels CH1, CH2, CH3, . . . , CHn may include a digital-analog converter DAC (e.g., a data digital-analog converter) and a buffer BUF (e.g., a data buffer). Here, the buffer BUF may be connected to the first data line through the first distribution circuit.

The digital-analog converter DAC may provide a first analog image signal corresponding to a bit value of the first digital image data signal supplied from the holding latch HOL through the level shifter LVS. For example, the digital-analog converter DAC may select a grayscale voltage corresponding to the bit value of the first digital image data signal from the holding latch HOL from the gamma circuit GMA and output the selected grayscale voltage as the first analog image signal.

The buffer BUF may receive the grayscale voltage (e.g., the analog image signal) from the digital-analog converter DAC and amplify and output the grayscale voltage. For example, the buffer BUF may amplify the grayscale voltage and output a data voltage. The data voltage from the buffer BUF may be provided to the first data line DL through the first distribution circuit. The buffer BUF may include an amplifier.

One of the plurality of output channels CH1, CH2, CH3, . . . , CHn may output a data voltage (e.g., a first data voltage Vd1) required for the first sub-pixel SP1 providing first light (e.g., red light), another of the plurality of output channels CH1, CH2, CH3, . . . , CHn may output a data voltage (e.g., a second data voltage Vd2) required for the second sub-pixel SP2 providing second light (e.g., blue light), and another one of the plurality of output channels CH1, CH2, CH3, . . . , CHn may output a data voltage (e.g., a third data voltage Vd3) required for the third sub-pixel SP3 providing third light (e.g., green light). For example, three adjacent output channels of the plurality of output channels CH1, CH2, CH3, . . . , CHn may provide the data voltages Vd1, Vd2, and Vd3 required respectively for three sub-pixels SP1, SP2, and SP3 included in one pixel PX.

The second data driving circuit 720 may have the same configuration as the first data driving circuit 710 described above. For example, the second data driving circuit 720 may include a shift register SHR, a sampling latch SAL, a holding latch HOL, a level shifter LVS, and a plurality of output channels CH1, CH2, CH3, . . . , CHn, as illustrated in FIG. 5. Here, each output channel of the second data driving circuit 720 may include a digital-analog converter and a buffer. Reference is made to FIG. 5 and a related description in relation to the shift register, the sampling latch, the holding latch, the level shifter, the digital-analog converter, and the buffer of the second data driving circuit 720.

In this case, the digital-analog converter of the second data driving circuit 720 may provide a second analog image signal corresponding to a bit value of a second digital image data signal supplied from the holding latch through the level shifter of the second data driving circuit 720. For example, the digital-analog converter of the second data driving circuit 720 may select a grayscale voltage corresponding to the bit value of the second digital image data signal from the holding latch of the second data driving circuit 720 from the gamma circuit GMA and output the selected grayscale voltage as the second analog image signal.

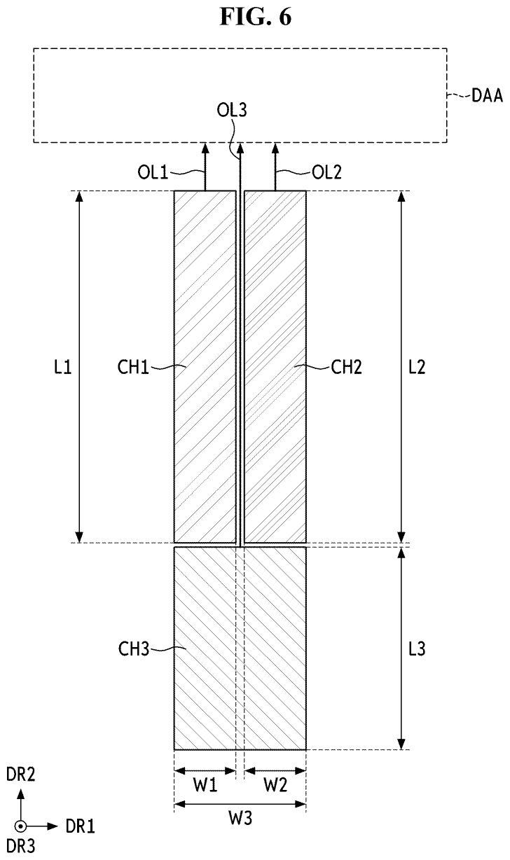

FIG. 6 is an array diagram of output channels for providing data voltages to sub-pixels included in one pixel. For example, FIG. 6 may be an array diagram for a first output channel CH1, a second output channel CH2, and a third output channel CH3 adjacent to each other in FIG. 5.

As illustrated in FIG. 6, the first output channel CH1 may provide the first data voltage Vd1 required for the first sub-pixel SP1 of the pixel PX, the second output channel CH2 may provide the second data voltage Vd2 required for the second sub-pixel SP2 of the pixel PX, and the third output channel CH3 may provide the third data voltage Vd3 required for the third sub-pixel SP3 of the pixel PX.

The first sub-pixel SP1, the second sub-pixel SP2, and the third sub-pixel SP3 included in one pixel PX may provide light of different colors. For example, the first sub-pixel SP1 connected to the first output channel CH1 may provide the red light, the second sub-pixel SP2 connected to the second output channel CH2 may provide the blue light, and the third sub-pixel SP3 connected to the third output channel CH3 may provide the green light.

The first output channel CH1, the second output channel CH2, and the third output channel CH3 connected to one pixel PX may be defined as a group output channel. For example, the group output channel connected to one pixel PX may include the first output channel CH1 connected to the first sub-pixel SP1, the second output channel CH2 connected to the second sub-pixel SP2, and the third output channel CH3 connected to the third sub-pixel SP3.

The first output channel CH1 and the second output channel CH2 may be adjacent to each other in the first direction DR1. The first output channel CH1 and the second output channel CH2 may be spaced apart from each other in the first direction DR1. The first output channel CH1 and the second output channel CH2 may have the same shape in a plan view.

The third output channel CH3 may be adjacent to the first output channel CH1 and the second output channel CH2 in the second direction DR2. The third output channel CH3 may have a different shape from the first output channel CH1 (or the second output channel CH2) in a plan view.

Each of the first to third output channels CH1 to CH3 may have a rectangular shape in a plan view.

A length L1 of the first output channel CH1 and a length L2 of the second output channel CH2 may be the same as each other.

A width W1 of the first output channel CH1 and a width W2 of the second output channel CH2 may be the same as each other.

A length L3 of the third output channel CH3 may be different from the length L1 (or L2) of the first output channel CH1 (or the second output channel CH2). For example, the length L3 of the third output channel CH3 may be smaller than the length L1 (or L2) of the first output channel CH1 (or the second output channel CH2).

A width W3 of the third output channel CH3 may be different from the width W1 (or W2) of the first output channel CH1 (or the second output channel CH2). For example, the width W3 of the third output channel CH3 may greater than the width W1 (or W2) of the first output channel CH1 (or the second output channel CH2).

The lengths L1, L2, and L3 of the respective output channels CH1, CH2, and CH3 described above may refer to sizes of the corresponding output channels in the second direction DR2, and the widths W1, W2, and W3 of the respective output channels CH1, CH2, and CH3 described above may refer to sizes of the corresponding output channels in the first direction DR1 perpendicularly crossing the second direction DR2.

The first output channel CH1 and the second output channel CH2 of the first to third output channels CH1 to CH3 may be closer to the display area DAA than the third output channel CH3 is. For example, the first output channel CH1 of the first output channel CH1 and the third output channel CH3 may be closer to the display area DAA than the third output channel CH3 is, and the second output channel CH2 of the second output channel CH2 and the third output channel CH3 may be closer to the display area DAA than the third output channel CH3 is.

The first output channel CH1 may output the first data voltage Vd1 through a first output line OL1, the second output channel CH2 may output the second data voltage Vd2 through a second output line OL2, and the third output channel CH3 may output the third data voltage Vd3 through a third output line OL3. In this case, the third output line OL3 may be located between the first output channel CH1 and the second output channel CH2.

A length of the first output line OL1 and a length of the second output line OL2 may be the same (or substantially the same) as each other.

A length of the third output line OL3 may be greater than the length of the first output line OL1 (or the second output line OL2).

According to some embodiments, the length L3 of the third output channel CH3 is smaller than the length L1 of the first output channel CH1 and the length L2 of the second output channel CH2, whereas the width W3 of the third output channel CH3 is greater than the width W1 of the first output channel CH1 and the width W2 of the second output channel CH2, the first output channel CH1 and the second output channel CH2 are adjacent to each other in a width direction of the third output channel CH3, and the third output channel CH3 is adjacent to the first output channel CH1 and the second output channel CH2 in a length direction of the first output channel CH1 (or the second output channel CH2), and accordingly, a length and a width of the group output channel including such first to third output channels CH1 to CH3 may be optimized. Accordingly, a great number of output channels may be integrated even in the non-display area NDA having a small area. In addition, an exposure process may be performed in one shot during a photolithography process for forming the data output circuit 712 including a plurality of group output channels described above.

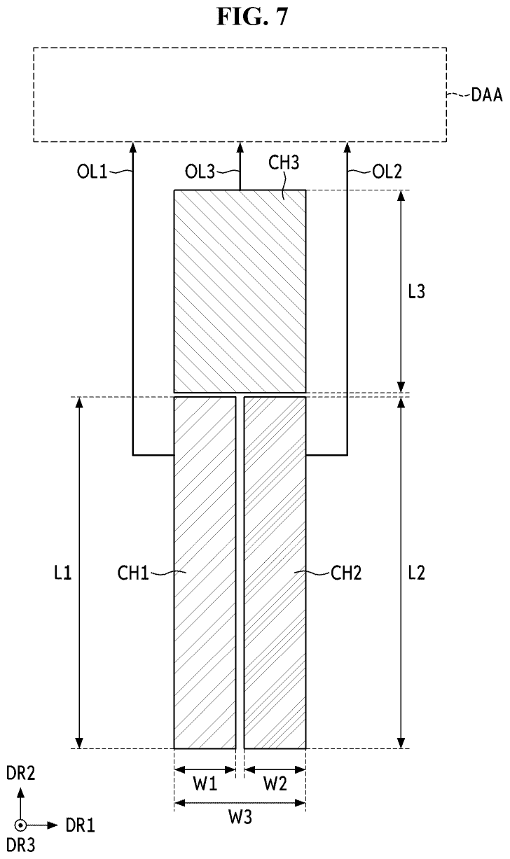

FIG. 7 is an array diagram of output channels for providing data voltages to sub-pixels included in one pixel. For example, FIG. 7 may be an array diagram for a first output channel CH1, a second output channel CH2, and a third output channel CH3 adjacent to each other in FIG. 5.

The embodiments of FIG. 7 are different from the embodiments of FIG. 6 described above in that a third output channel CH3 is closer to the display area than the other output channels are, and such a difference will be mainly described below.

As illustrated in FIG. 7, the third output channel CH3 of the first to third output channels CH1 to CH3 may be closer to the display area DAA than the first output channel CH1 and the second output channel CH2 are. For example, the third output channel CH3 of the first output channel CH1 and the third output channel CH3 may be closer to the display area DAA than the first output channel CH1 is, and the third output channel CH3 of the second output channel CH2 and the third output channel CH3 may be closer to the display area DAA than the second output channel CH2 is.

A length of the first output line OL1 and a length of the second output line OL2 may be the same (or substantially the same) as each other. Each of the first output line OL1 and the second output line OL2 may have a bent shape.

A length of the third output line OL3 may be smaller than the length of the first output line OL1 (or the second output line OL2).

According to some embodiments as illustrated in FIG. 7, the first output channel CH1 and the second output channel CH2 may be in contact with each other without being spaced apart from each other in the first direction DR1.

The display device 10 according to some embodiments may be applied to various electronic devices. An electronic device according to some embodiments includes the display device 10 described above, and may further include modules or devices having other additional functions in addition to the display device 10.

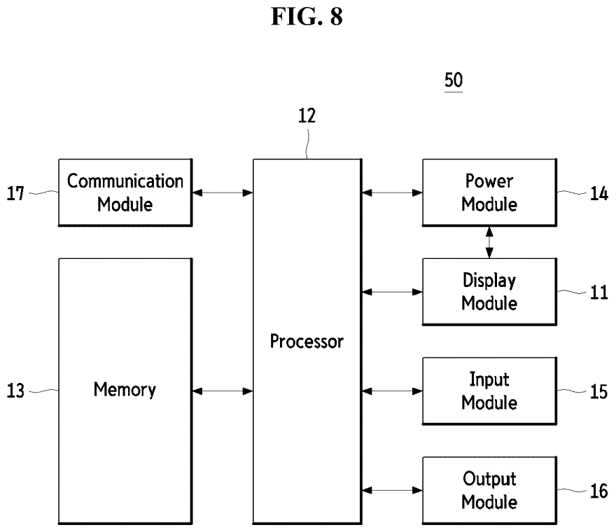

FIG. 8 is a block diagram showing aspects of an electronic device according to some embodiments.

Referring to FIG. 8, an electronic device 50 according to some embodiments may include a display module 11, a processor 12, a memory 13, and a power module 14. The electronic device 50 may further include an input module 15, a non-image output module 16, and/or a communication module 17.

The electronic device 50 may output various information in the form of an image through the display module 11. When the processor 12 executes an application stored in the memory 13, image information provided by the application may be provided to a user through the display module 11. The power module 14 may include a power supply module such as a power adapter or a battery device and a power conversion module converting power supplied by the power supply module to generate power required for an operation of the electronic device 50. The input module 15 may provide input information to the processor 12 and/or the display module 11. The non-image output module 16 may serve to receive information other than an image received from the processor 12, such as sound information, haptic information, and light emitting information, and provide the received information to the user. The communication module 17 is a module in charge of transmitting and receiving information between the electronic device 50 and an external device, and may include a receiving unit and a transmitting unit.

At least one of the respective components of the above-described electronic device 50 may be included in the display device according to the above-described embodiments. In addition, some of individual modules functionally included in one module may be included in the display device, and the others of the individual modules may be provided separately from the display device. For example, the display device may include the display module 11, and the processor 12, the memory 13, and the power module 14 may be provided in the form of other devices within the electronic device 50 rather than the display device.

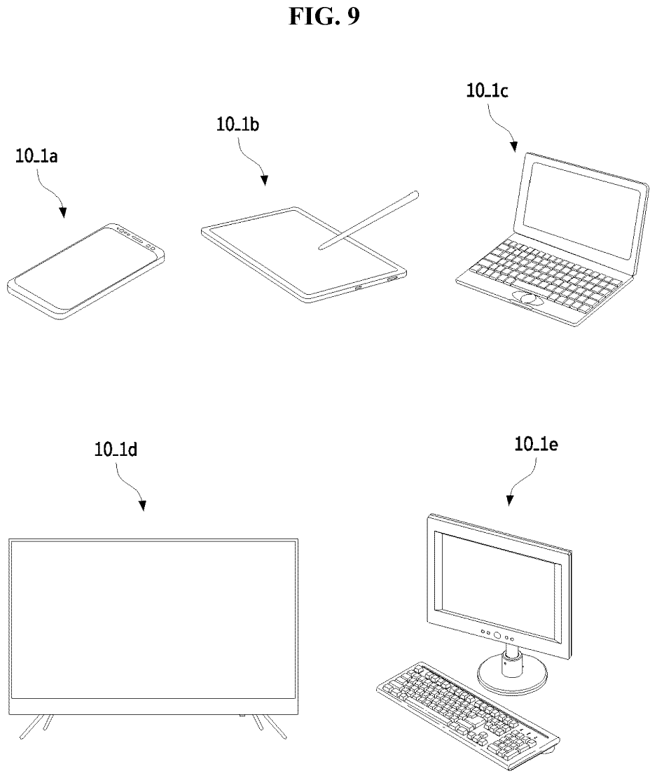

FIGS. 9 to 11 are schematic views of electronic devices according to various embodiments. FIGS. 9 to 11 illustrate examples of various electronic devices to which the display device 10 according to embodiments is applied.

FIG. 9 illustrates a smartphone 10_1a, a tablet PC 10_1b, a laptop computer 10_1c, a television (TV) 10_1d, and a monitor 10_1e for a desktop computer as examples of the electronic devices.

The smartphone 10_1a may include an input module such as a touch sensor and a communication module in addition to the display module 11. The smartphone 10_1a may process information received through the communication module or other input modules and display the processed information through the display module of the display device.

Each of the tablet PC 10_1b, the laptop computer 10_1c, the TV 10_1d, and the monitor 10_1e for a desktop computer may include a display module and an input module, similar to the smartphone 10_1a, and may further include a communication module in some cases.

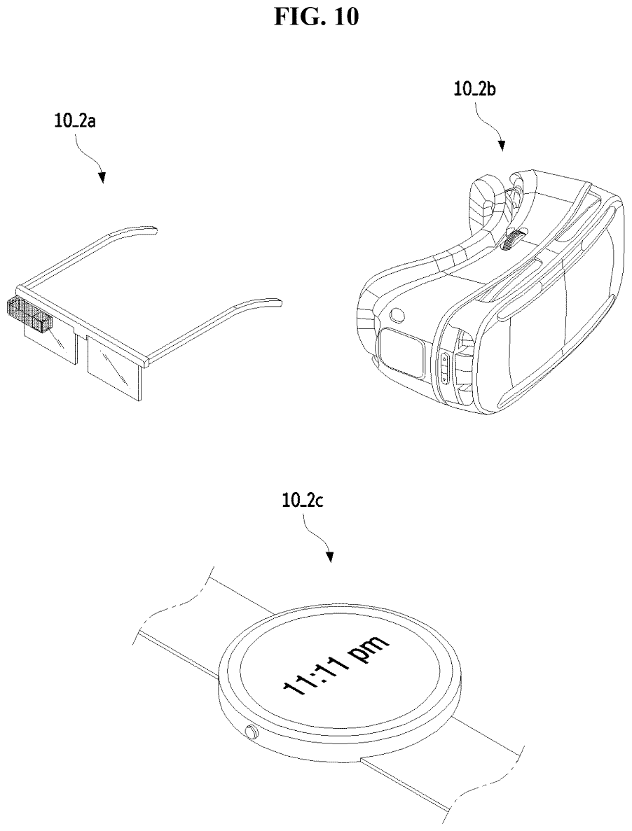

FIG. 10 illustrates a case where an electronic device including a display module is applied to a wearable electronic device. The wearable electronic device may be a smart glasses 10_2a, a head mounted display 10_2b, a smart watch 10_2c, or the like.

The smart glasses 10_2a and the head mounted display 10_2b may include a display module emitting a display image and a reflector reflecting the emitted display image and providing the emitted display image to user's eyes, and accordingly, may provide a virtual reality screen or an augmented reality screen to the user.

The smart watch 10_2c may include a biometric sensor as an input device, and may provide biometric information recognized through the biometric sensor to the user through the display module.

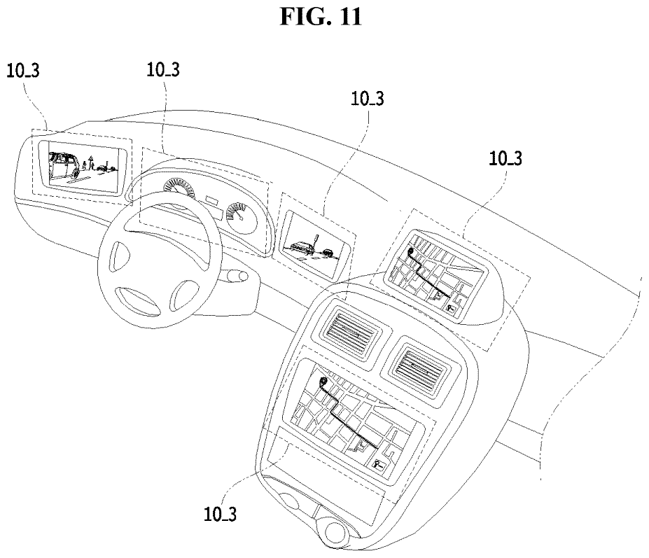

FIG. 11 illustrates a case where an electronic device including a display module is applied to a vehicle. For example, an electronic device 10_3 may be applied to an instrument board, a center fascia, or the like, of the vehicle or applied to a center information display (CID) located on a dashboard of the vehicle, a room mirror display substituting for a side-view mirror, or the like.

In concluding the detailed description, those skilled in the art will appreciate that many variations and modifications can be made to the disclosed embodiments without departing from the spirit and scope of embodiments according to the present disclosure. Therefore, the disclosed embodiments of the invention are used in a generic and descriptive sense only and not for purposes of limitation.

What is claimed is:

1. A display device comprising:
a display panel including a display area and a non-display area;
a data driving circuit in the non-display area; and
a gamma circuit configured to generate a plurality of grayscale voltages,
wherein the data driving circuit includes a data processing circuit configured to process digital image data and a data output circuit configured to convert the digital image data from the data processing circuit into an analog image signal based on the plurality of grayscale voltages from the gamma circuit and to provide the analog image signal to the display area,
the data output circuit includes a first output channel, a second output channel, and a third output channel that are connected to the data processing circuit, and
the first output channel and the second output channel are adjacent to each other in a width direction of the third output channel, and the third output channel is adjacent to the first output channel and the second output channel in a length direction of the first output channel.

2. The display device of claim 1, wherein a length of the third output channel is smaller than a length of the first output channel and a length of the second output channel.

3. The display device of claim 2, wherein a width of the third output channel is greater than a width of the first output channel and a width of the second output channel.

4. The display device of claim 3, wherein the length of the first output channel and the length of the second output channel are equal to each other, and
the width of the first output channel and the width of the second output channel are equal to each other.

5. The display device of claim 4, wherein in a plan view, an area of the first output channel, an area of the second output channel, and an area of the third output channel are equal to each other.

6. The display device of claim 1, wherein the first and second output channels of the first to third output channels are closer to the display area than the third output channel is.

7. The display device of claim 6, wherein the first output channel and the second output channel are spaced apart from each other by a selected interval in a width direction of the first output channel.

8. The display device of claim 7, wherein an output line of the third output channel is between the first output channel and the second output channel.

9. The display device of claim 1, wherein the third output channel of the first to third output channels is closer to the display area than the first and second output channels are.

10. The display device of claim 9, wherein each of an output line of the first output channel and an output line of the second output channel has a bent shape.

11. The display device of claim 1, wherein a pixel of the display area includes a first sub-pixel, a second sub-pixel, and a third sub-pixel that provide light of different colors.

12. The display device of claim 11, wherein the first output channel is connected to the first sub-pixel,
the second output channel is connected to the second sub-pixel, and
the third output channel is connected to the third sub-pixel.

13. The display device of claim 11, wherein
the first sub-pixel is configured to provide red light,
the second sub-pixel is configured to provide blue light, and
the third sub-pixel is configured to provide green light.

14. The display device of claim 1, wherein at least one of the first to third output channels includes:
a digital-analog converter connected to the data processing circuit; and
a buffer connected to the digital-analog converter.

15. The display device of claim 1, wherein in a plan view, a shape of the first output channel and a shape of the second output channel are equal to each other.

16. The display device of claim 15, wherein in the plan view, a shape of the third output channel and the shape of the first output channel are different from each other.

17. The display device of claim 1, wherein the gamma circuit is in the non-display area between the data processing circuit and the data output circuit.

18. An electronic device comprising a display device configured to display images,
wherein the display device includes:
a display panel including a display area and a non-display area;
a data driving circuit in the non-display area; and
a gamma circuit configured to generate a plurality of grayscale voltages,
the data driving circuit includes a data processing circuit configured to process digital image data and a data output circuit configured to convert the digital image data from the data processing circuit into an analog image signal based on the plurality of grayscale voltages from the gamma circuit and to provide the analog image signal to the display area,
the data output circuit includes a first output channel, a second output channel, and a third output channel that are connected to the data processing circuit, and
the first output channel and the second output channel are adjacent to each other in a width direction of the third output channel, and the third output channel is adjacent to the first output channel and the second output channel in a length direction of the first output channel.

19. The electronic device of claim 18, wherein a length of the third output channel is smaller than a length of the first output channel and a length of the second output channel, and
a width of the third output channel is greater than a width of the first output channel and a width of the second output channel.

20. The electronic device of claim 18, wherein the electronic device is one of a smartphone, a tablet personal computer (PC), a laptop computer, a television (TV), a monitor for a desktop computer, a smart glasses, a smart watch, a head mounted display, or a vehicle.
